(19) United States
(12) Patent Application Publication
(10) Pub. No.: US 2024/0282515 A1
(43) Pub. Date: Aug. 22, 2024

(54) COIL FABRICATION PROCESS INCLUDING IN SITU POTTING

(71) Applicants: James J. Steppan, Park City, UT (US); Thomas A. Meaders, West Valley City, UT (US); Byron S. Millet, Woods Cross, UT (US); Lee C. Sorensen, West Jordan, UT (US)

(72) Inventors: James J. Steppan, Park City, UT (US); Thomas A. Meaders, West Valley City, UT (US); Byron S. Millet, Woods Cross, UT (US); Lee C. Sorensen, West Jordan, UT (US)

(21) Appl. No.: 18/582,216

(22) Filed: Feb. 20, 2024

Related U.S. Application Data
(60) Provisional application No. 63/446,552, filed on Feb. 17, 2023.

(51) Int. Cl. H01F 41/066; H01F 5/06; H01F 41/12

(52) U.S. Cl. CPC H01F 41/066; H01F 5/06; H01F 41/12

(57) ABSTRACT

A fabrication process for coils to be used in high-temperature operations, such as coil for use in electromagnets for thrusters. The fabrication process includes preparing a slurry of castable inorganic composite potting materials in water. A wire, such as a copper wire is coated with the slurry using a coating device. The wet coated wire can then be wound on a filament winding device, in near real-time, to obtain a wet coil. The wet coil can be kept for setting and drying, and thereafter the dried coil can be cured under high temperature and/or pressure.

### CROSS-REFERENCE TO RELATED APPLICATIONS

This application claims priority from a U.S. Provisional Patent Appl. Ser. No. 63/446,552, filed on Feb. 17, 2023, which is incorporated herein by reference in its entirety.

### FIELD OF INVENTION

The present invention relates to a fabrication process of coils for use in high-temperature operations, and more particularly, the present invention relates to coil winding and in situ potting process.

### BACKGROUND

Electric propulsion systems have been an important topic in research in the past few decades. Electric propulsion systems offer several advantages and opportunities over chemical propulsion systems. The success of electric propulsion systems is chiefly dependent on the operation of electromagnets at high temperatures. Hall effect thrusters, a type of electric propulsion system, experience temperature swings from −40° C. to 600° C. during regular operation on plasma-wetted components, and cathode temperatures exceeding 1000° C. Thus, thermal management in an integrated electric propulsion system is challenging. Potting or encapsulated coils are used; however, the insulation is susceptible to degradation during thruster operations. Thus, the failure of coils is the major reason behind the reduced life of electric propulsion thrusters and early failures.

A need is therefore appreciated for improvements in the materials and/or fabrication process for coils that allow longer life in high-temperature operations.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a fabrication process for coils with an in-situ potting process that allows for the long life of coils in high-temperature operations.

Another object of the present invention is that the fabrication process allows for reducing the total life cycle cost of the electric propulsion thrusters.

Still, another object of the present invention is that the potting and insulation failures can be eliminated or significantly reduced.

Yet another object of the present invention is that the fabrication process is compatible with high ampere turn and multi-layer electromagnets.

A further object of the present invention is that the fabrication process helps avoid performance degradation in high temperature operational conditions.

In one aspect, disclosed is a fabrication process for coils to be used in high-temperature operations, the fabrication process comprises preparing a slurry of castable inorganic composite potting materials in water; coating a wire with the slurry using a coating device; winding, the wet coated wire egressed from the coating device, on a filament winding device, in near real-time, to obtain a wet coil; and upon drying the wet coil, curing a dried coil to obtain a cured coil. The coated wire in combination with fibers can also be co-wounded. The fibers are selected from glass fibers, ceramic fibers, or a combination thereof. The wire can be made of copper.

In one aspect, disclosed is an electromagnet for use in high-temperature operations. The electromagnet comprises a coil fabricated by a method comprising the steps of preparing a slurry of castable inorganic composite potting materials in water; coating a wire with the slurry using a coating device; and winding, the wet coated wire egressed from the coating device, in near real time, on a filament winding device, to obtain a wet coil; and upon drying the wet coil, curing a dried coil to obtain a cured coil.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram illustrating the process according to an exemplary embodiment of the present invention.

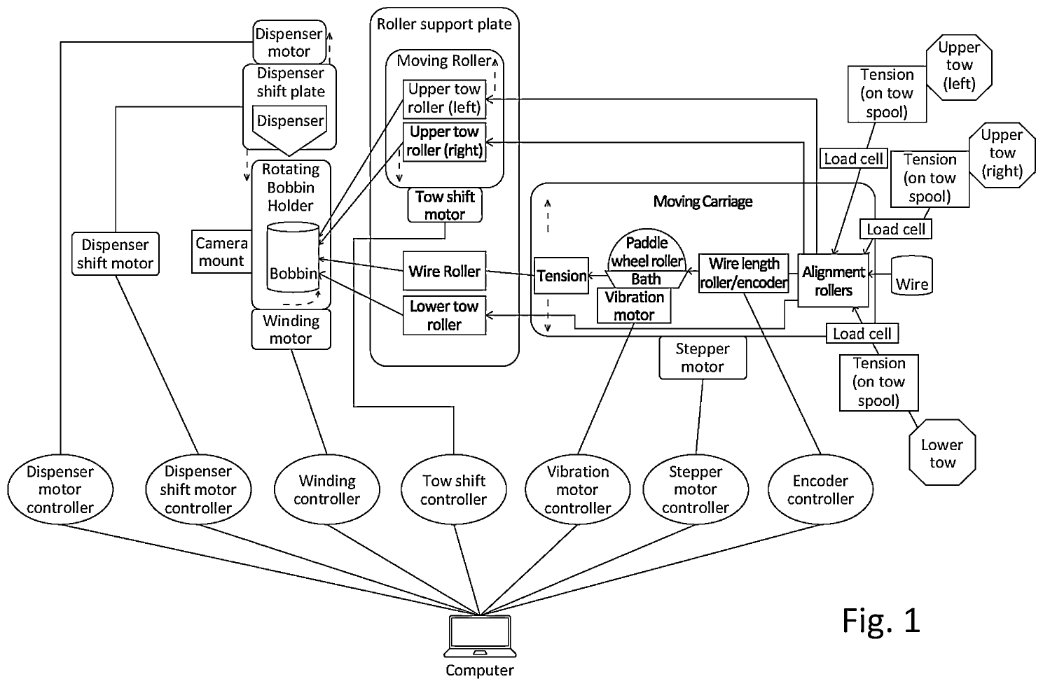

FIG. 2 shows a device for coating a wire, according to an exemplary embodiment of the present invention.

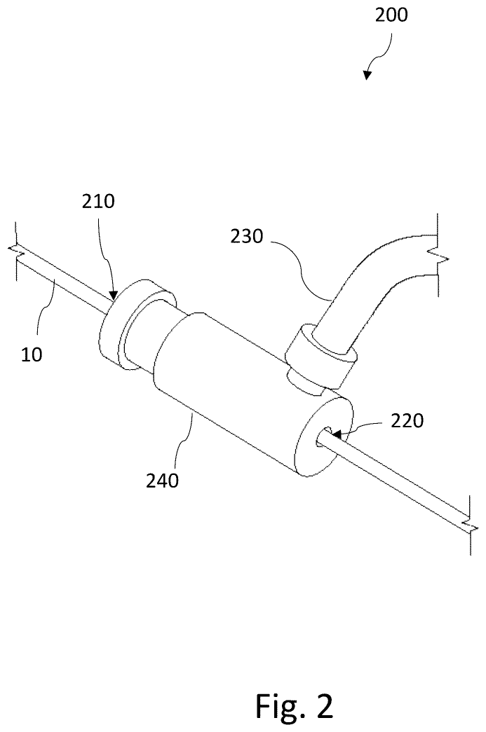

FIG. 3 is a flowchart illustrating the process, according to an exemplary embodiment of the present invention.

FIGS. 4a-4d shows cross sections of different wires potted with CICP materials, wherein a) VIP wire after T=500 C exposure, b) Ceramawire® (Wind34), c) No-clad Cu, and d) Cu wire/4040 insulation.

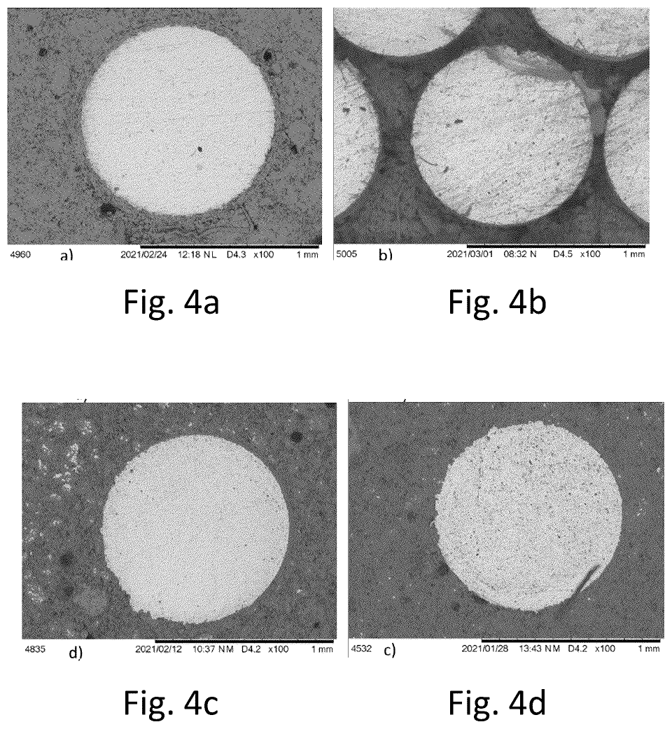

FIG. 5 is a table showing the outgassing test results, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is a fabrication process for coils that includes coil winding with in-situ potting allowing the fabricated coils to have significant resistance to potting and insulation failures. The disclosed fabrication process utilizes castable inorganic composite potting materials, referred to herein as CICP materials. The fabrication process further includes conventional or accelerated hot press curing. The disclosed fabrication process can significantly extend the temperature limits of conventional polymeric and/or ceramic potting materials thereby minimizing or eliminating the instances of potting and insulation failures.

Conventionally, ceramic material is used for potting in High-temperature electromagnet (HTEM) coils to fill the gaps between the windings and to be free of voids. Unfortunately, in practice, the ceramic potting compound develops cracks due to the large startup thermal gradients and differences in the coefficient of thermal expansion (CTE) of the constituent materials. The disclosed fabrication process intends to improve the robustness by minimizing porosity and adding reinforcing fibers to the CICP materials.

Disclosed is a process for the fabrication of high-temperature coils. These high-temperature coils can be used in a variety of high-temperature operations, such as electromagnets, actuators, transformers, and the like. The fabrication process can use copper wire, which may or may not be coated with a high-temperature-resistant coating material such as ceramic or glass. In the fabrication process, the wire can be passed through a slurry containing the CICP material. Examples of CICP materials include alkali-bonded material, such as a geopolymer, a silicate-bonded material, a phosphate-bonded material, a glass-bonded material, etc. The fabrication process includes winding the wire onto a mandrel in such a way that some of the CICP material is coated on the surface of the wire and will ultimately end up on the coil wound device as a potting material. Examples of mandrels include a rod, bobbin, core, laminate, tube, etc. It should be noted that the choice of a particular CICP material or a particular mandrel (or the size or shape of such a mandrel) in no way limits the scope of the present invention.

In some preferred embodiments, the coil can be co-wound with one or more types of ceramic fiber, glass fiber, and the like so that at least some of the ceramic or glass fibers will be present in between individual turns of the conductive wire and/or between the conductive wire and the mandrel. Said fibers provide electrical insulation between the individual turns and/or between the coil and the mandrel. The coil can be wound on a device, such as a filament winder. Examples of ceramic fibers include that of basalt and alumina. In some embodiments, the winding process can be followed by a drying process allowing for the potting material to set and dry.

In some preferred embodiments, the winding process may be followed by a curing process that may involve the application of an elevated temperature and/or pressure. A typical apparatus, such as a furnace, oven, heating coil, heat tape, radiant heaters, hot air blowers, etc. may be used for the application of temperature.

A typical apparatus, such as a die (e.g., a multi-part assembly), a compression fixture, a crimping tool, an isostatic pressure rig, etc. may be used for the application of pressure. In certain implementations, the high pressure and high temperature may be applied together. Note that the temperature and pressure chosen may depend, to be optimal for, on the CICP material. The selection of CICP material may depend on a variety of factors, such as a specific value or range of temperature and/or pressure in no way limits the scope of this invention/technology.

The disclosed fabrication process enables flexible design options using high temperature and energy materials. The disclosed fabrication process allows for improved reliability and longer life of high-temperature electromagnets. There can be potential cost reduction of potting materials and improved acceptance testing. Also, in the case of thrusters, the life of thrusters can be increased thus providing huge cost savings. The disclosed fabrication process may find commercial use in the space industry and thermal management applications. The disclosed fabrication process can be used for miniaturing High-temperature electromagnets (HTEM) that can be used in thrusters, such as Hall-effect thrusters. Various thermal management applications include the potting of hot components, subassemblies, and surfaces in high-temperature environments for gas turbine engines, furnaces, processing equipment, aerospace, and automotive. Moreover, the disclosed fabrication process allows the use of copper wires, further bringing down the cost. It is to be noted that other materials of the wires, such as Nickel or high temperature alloys are within the scope of the present invention.

In certain implementations, the CICP materials may include metakaolin-based geopolymers, aluminosilicate-based geopolymers, and ceramic-based, HT silicone before and after HT thermal exposure and thermal cycling. In certain implementations, an alumina based CICP material was selected as the best potting material. The filament used was wet wire preferably with dry basalt tow was in-situ potted using the alumina-based CICP material. The potted material on the coil was then processed further using conventional or accelerated hot press curing. The product showed excellent isolation resistance from the bobbin as well as adjacent wires.

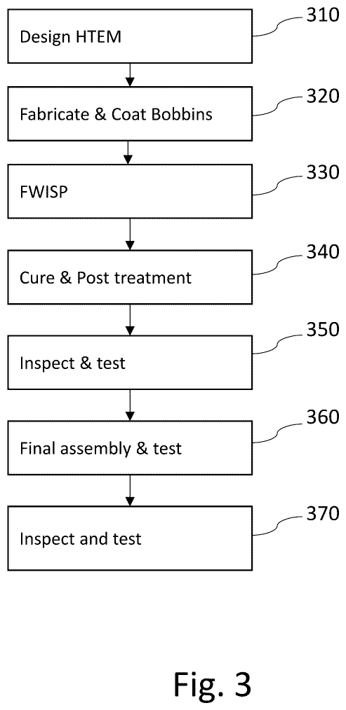

Referring to FIG. 3 illustrates wire coating with CICP material and dispensing the In-Situ coating wires using a PTFE flow-through dispenser 200. The dispenser includes a wire inlet 210 through which a wire, such as copper wire 10 can be received. The dispenser includes an outlet 220 through which a coated wire can be extruded and can be dispensed, in in-situ to a coil winding device. A tube 230 can be seen attached to the body 240 of the dispenser, and through this tube, CICP material can be fed into the dispenser. The tubing is used to connect a dispensing syringe to a flow-through cell.

### Example 1

A master batch of CICP material powder was prepared in seven individual batches. 400 grams of CICP material powder were milled for 1 hour and sieved through a 125 μm sieve. This was used for wet winds. The CICP material powder was with water in a ratio of 1:19 for initial dispensing trials and generation of Modulus of Rupture (MOR) bars for flexural strength characterizations. It was found through additional wet winding trials that a CICP material-to-water ratio of 1:18 produces better results when dispensing through the in-line dispenser.

In certain implementations, a layer of CICP material can be applied over the bobbins, such as metal bobbins to ensure electrical isolation between the wire and the bobbin on which the wire is wound. The CICP material can be sprayed or applied using a brush. A surfactant can be added to improve the sprayability of the CICP material. Preferably, 0.2% w/w of surfactant, based on CICP material powder, can be added. It was found that the use of 0.1% surfactant resulted in undesired effects i.e., lack of perfect isolation. The coating with the 0.2% surfactant showed particularly good electrical isolation.

Referring to FIG. 3 which illustrates a process according to an exemplary embodiment of the present invention. First, the requirements for manufacturing the High temperature electromagnet (HTEM) coils can be standardized, at step 310. This may involve receiving wire size and type of wire material, and Bobbin size and material type. Then, the filament winding machine can be prepared, and bobbins can be loaded on the filament winding machine, at step 320. The user can inspect the different parameters of the machine. Also, CICP material can be spray coated on the Bobbin. The CICP material slurry can be prepared as described above for the coating process of the wire and for the spray coating on the bobbin. The wire either uncoated or coated can then be coated with the CICP slurry as described above, at step 330. The CICP material can be prepared with standardized materials. The wire can be copper wire as such without any coating. Also, wire coated with fibers, such as ceramic fibers can be used. The wet coated wire can be in-situ received on the filament winding machine and wound into a wet coil. The wet coil can then be subjected to cure and post treatment, at step 340. In curing, a controlled atmosphere can be used (T vs time). The cured coil can be inspected and subjected to testing procedures, such as resistance, isolation, and magnetic, at step 350. The cured coil can then be sent for final assembly, and welded, at step 360. Final inspection and testing can be done, at step 370.

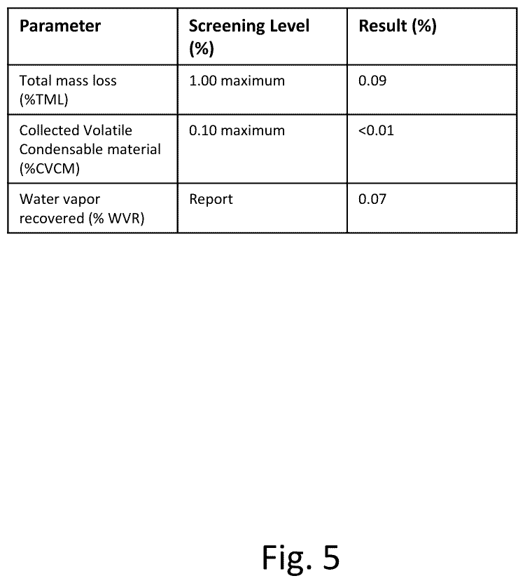

The table in FIG. 5 shows the cured CICP meets ASTM E595 outgassing requirements. HTEM and/or witness samples produced by the fabrication process for coils with in-situ potting were characterized for wire length resistance, isolation resistance, magnetic flux, and mechanical properties.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A fabrication process for coils to be used in high-temperature operations, the fabrication process comprises:
preparing a slurry of castable inorganic composite potting materials in water;
coating a wire with the slurry using a coating device to obtain a wet coated wire;
winding, the wet coated wire egressed from the coating device, on a filament winding device, in near real-time, to obtain a wet coil; and
upon drying the wet coil, curing a dried coil to obtain a cured coil.

2. The fabrication process of claim 1, wherein the coated wire in combination with fibers is co-wounded.

3. The fabrication process of claim 2, wherein the fibers are selected from glass fibers, ceramic fibers, or a combination thereof.

4. The fabrication process of claim 1, wherein the wire is made of copper.

5. An electromagnet for use in high-temperature operations, the electromagnet comprises:
a coil fabricated by a method comprising the steps of:
preparing a slurry of castable inorganic composite potting materials in water;
coating a wire with the slurry using a coating device to obtain a wet coated wire; and
winding, the wet coated wire egressed from the coating device, in near real time, on a filament winding device, to obtain a wet coil; and
upon drying the wet coil, curing a dried coil to obtain a cured coil.

6. The electromagnet of claim 5, wherein the coated wire in combination with fibers is co-wounded.

7. The electromagnet of claim 6, wherein the fibers are selected from glass fibers, ceramic fibers, or a combination thereof.

8. The electromagnet of claim 5, wherein the wire is made of copper.
